(19) United States
(12) Patent Application Publication
(10) Pub. No.: US 2026/0270920 A1
(43) Pub. Date: Sep. 10, 2026

(54) METHOD AND APPARATUS FOR HANDLING IAB NODE RELEASE, DEREGISTRATION AND/OR RE-REGISTRATION

(71) Applicant: TELEFONAKTIEBOLAGET LM ERICSSON (PUBL), Stockholm (SE)

(72) Inventors: Paul Schliwa-Bertling, LJUNGSBRO (SE); Qian Chen, MÖLNDAL (SE); Filip Barac, HUDDINGE (SE)

(73) Assignee: TELEFONAKTIEBOLAGET LM ERICSSON (PUBL), Stockholm (SE)

(21) Appl. No.: 19/166,239

(22) PCT Filed: Mar. 15, 2024
(86) PCT No.: PCT/IB2024/052541

§ 371 Date: Sep. 17, 2025

(30) Foreign Application Priority Data
Mar. 17, 2023 (WO) PCT/EP2023/056893

(51) Int. Cl. H04W 60/06

(52) U.S. Cl. CPC H04W 60/06

(57) ABSTRACT

Embodiments of the present disclosure provide method and apparatus for handling IAB node release, deregistration and/or re-registration. A method performed by a mobility management node may comprise obtaining information that an integrated access and backhaul (IAB) node is emptied and/or ready to be released and/or deregistered and/or re-registered. The method may further comprise triggering a procedure for a release and/or a deregistration and/or a re-registration of the IAB node.

### TECHNICAL FIELD

The non-limiting and exemplary embodiments of the present disclosure generally relate to the technical field of communications, and specifically to methods and apparatuses for handling integrated access and backhaul (IAB) node release, deregistration and/or re-registration.

### BACKGROUND

This section introduces aspects that may facilitate a better understanding of the disclosure. Accordingly, the statements of this section are to be read in this light and are not to be understood as admissions about what is in the prior art or what is not in the prior art.

Integrated access and backhaul (IAB) enables wireless relaying in a radio access network (RAN). A relaying node may be referred to as IAB node. The IAB node may support access and backhauling via Radio Access Technology (RAT) such as new radio (NR). A terminating node of RAT backhauling on network side may be referred to as the IAB-donor, which may represent a RAN node with additional functionality to support IAB. Backhauling can occur via a single or via multiple hops.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Third Generation Partnership Project (3GPP) release 18 is pursuing a work item related to vehicle mounted radio base station, i.e., mobile base station relay. The baseline for the work IAB architecture is developed in 3GPP release 16/17 where IAB node is stationary.

During the work, it is specified that a mobile IAB node (mIAB) may be not authorized to act as mIAB due to subscription data. Then it may be up to an operator decision/policy if such mIAB node can be accepted as normal user equipment (UE) in fifth generation system (5GS) or whether it shall be deregistered from the 5GS.

3GPP release 16/17 specifies that an IAB node comprises IAB-UE/IAB-DU (Distributed Unit) part (see clause 5.35 of 3GPP TS 23.501 V18.0.0, the disclosure of which is incorporated by reference herein in its entirety). The IAB-UE part registers itself to the 5GS system as “UE” first via gNB (with donor function to manage the IAB node). After the registration, the IAB-DU part can be configured to act as DU with managed from the Central Unit (CU) part in the donor-gNB (e.g., IAB-DU+donor-gNB-CU works as normal split gNB-CU+gNB-DU as specified in 3GPP TS 38.401 V17.3.0, the disclosure of which is incorporated by reference herein in its entirety). The UEs then can access the 5GS via the cell broadcasted by IAB-DU.

Clause 8.9.10 of 3GPP TS 38.401 V17.3.0 describes IAB node orderly release as following.

For orderly release, the IAB-donor-CU can remove the F1 interface connection to the IAB-DU without releasing the IAB-MT. If the IAB-MT needs to be released, IAB-MT will perform the deregistration procedure. If both F1 interface and IAB-MT need to be released, the IAB-donor-CU should remove the F1 interface to the IAB-DU before it releases the collocated IAB-MT. The deregistration procedure is the same as the UE deregistration procedure. The IAB-donor-CU hands over the UEs or child IAB nodes currently connected to the IAB node's cell(s) to another cell(s), or releases the UEs and may stop accepting incoming handovers or connections to the IAB node that is about to be released. The IAB-donor-CU may also update/release the BH RLC channels in the intermediate hops. At this point, the F1 interface will be released and the corresponding SCTP associations will be removed.

When an IAB node needs to be taken out from the system (e.g. Subscription data for the IAB node is updated and an (previously authorized) IAB node is no longer authorized to operate as an IAB node in the network, clause 8.9.10 of 3GPP TS 38.401 V17.3.0 states that donor-IAB-CU (e.g., donor-gNB CU) shall first move the connected UEs to other cells, and then it can trigger the release F1 connection between IAB-DU and donor-IAB-CU. The final step can be to deregister the IAB-MT (Mobile Termination) from the system if the operator decides to do so.

IAB-MT provides IAB node function that terminates the Uu interface to the parent node using the procedures and behaviors specified for UEs unless stated otherwise. IAB-MT function used in 38-series of 3GPP Specifications corresponds to IAB-UE function defined in 3GPP TS 23.501 V18.0.0.

However, there is no solution enabling the network to know that the IAB node is ready to be de-registered or released or deregistered from the network such as 5GS (e.g., which may be after all the connected UEs and/or descendant nodes and/or child IAB nodes are moved or handed over to other cells or served by other serving nodes or released).

To overcome or mitigate at least one of above mentioned problems or other problems, the embodiments of the present disclosure propose an improved solution for handling IAB node release, deregistration and/or re-registration.

In a first aspect of the disclosure, there is provided a method performed by a mobility management node. The method may comprise obtaining information that an integrated access and backhaul (IAB) node is emptied and/or ready to be released and/or deregistered and/or re-registered. The method may further comprise triggering a procedure for a release and/or a deregistration and/or a re-registration of the IAB node.

In an embodiment, the information that the IAB node is emptied and/or ready to be released and/or deregistered and/or re-registered may indicate at least one of the IAB node does not serve any terminal device and/or any descendant IAB node and/or any child IAB node, or all terminal devices and/or all descendant IAB nodes and/or all child IAB nodes connected via the IAB node are moved or handed over to at least one other cell and/or served by at least one other IAB node or other radio access network (RAN) node or released, or a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.

In an embodiment, the method may further comprises receiving the information that the IAB node is emptied and/or ready to be released and/or deregistered and/or re-registered from an IAB donor serving the IAB node.

In an embodiment, the information that the IAB node is emptied and/or ready to be released and/or deregistered and/or re-registered may be received from the IAB donor serving the IAB node in a next generation application protocol message or an S1 application protocol message.

In an embodiment, the information that the IAB node is emptied and/or ready to be released and/or deregistered and/or re-registered may be comprised in a user equipment context release request or in a cause parameter. The cause parameter may be added with a cause value indicating the IAB node is emptied and/or ready to be released and/or deregistered and/or re-registered.

In an embodiment, the information that the IAB node is emptied and/or ready to be released and/or deregistered and/or re-registered may comprise at least one of single information indicating that the IAB node no longer serves a terminal device and a descendant IAB node and a child IAB node, or first information indicating that the IAB node no longer serves a terminal device and/or second information indicating that the IAB node no longer serves a descendant IAB node and/or a child IAB node.

In an embodiment, the method may further comprise monitoring at least one terminal device and/or at least one descendant IAB node and/or at least one child IAB node connected via the IAB node. The information that the IAB node is emptied and/or ready to be released and/or deregistered and/or re-registered may be obtained based on a monitoring result.

In an embodiment, the monitoring may be performed when the IAB node, one or more terminal devices served by the IAB node, one or more descendant IAB nodes of the IAB node and one or more terminal devices served by the descendant IAB nodes are served by a same mobility management node.

In an embodiment, when all terminal devices served by the IAB node and all child IAB nodes of the IAB node have been handed over or moved to at least one other cell or served by at least one other IAB node or other RAN node or released, the procedure for the release and/or the deregistration and/or the re-registration of the IAB node may be triggered.

In an embodiment, the method may further comprise sending to an IAB donor serving the IAB node a message informing the IAB donor that the IAB node is no longer authorized to act as IAB node.

In an embodiment, the mobility management node comprises at least one of an access and mobility management function (AMF) or a mobile management entity (MME).

In a second aspect of the disclosure, there is provided a method performed by an IAB donor. The method may comprise determining that an IAB node is emptied and/or ready to be released and/or deregistered and/or re-registered. The method may further comprise sending information that the IAB node is emptied and/or ready to be released and/or deregistered and/or re-registered to a mobility management node. The information that an IAB node is emptied and/or ready to be released and/or deregistered and/or re-registered may be used by the mobility management node to trigger a procedure for a release and/or a deregistration and/or a re-registration of the IAB node.

In an embodiment, the information that the IAB node is emptied and/or ready to be released and/or deregistered and/or re-registered may indicate at least one of the IAB node does not serve any terminal device and/or any descendant IAB node and/or any child IAB node, or all terminal devices and/or all descendant IAB nodes and/or all child IAB nodes connected via the IAB node are moved or handed over to at least one other cell and/or served by at least one other IAB node or other radio access network (RAN) node or released, or a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.

In an embodiment, the information that the IAB node may comprise at least one of single information indicating that the IAB node no longer serves a terminal device and a descendant IAB node and a child IAB node, or first information indicating that the IAB node no longer serves a terminal device and/or second information indicating that the IAB node no longer serves a descendant IAB node and/or a child IAB node.

In an embodiment, the information that the IAB node is emptied and/or ready to be released and/or deregistered and/or re-registered may be sent to the mobility management node in next generation application protocol message or an S1 application protocol message.

In an embodiment, the information that the IAB node is emptied and/or ready to be released and/or deregistered and/or re-registered may be comprised in a user equipment context release request or in a cause parameter, wherein the cause parameter is added with a cause value indicating the IAB node is emptied and/or ready to be released and/or deregistered and/or re-registered.

In an embodiment, the method may further comprise receiving a message informing the IAB donor that the IAB node is no longer authorized to act as IAB node from the mobility management node.

In an embodiment, the mobility management node may comprise at least one of an access and mobility management function (AMF), or a mobile management entity (MME).

In a third aspect of the disclosure, there is provided a mobility management node. The mobility management node comprises a processor and a memory coupled to the processor. Said memory contains instructions executable by said processor. Said mobility management node may be operative to obtain information that an integrated access and backhaul (IAB) node is emptied and/or ready to be released and/or deregistered and/or re-registered. Said mobility management node may be further operative to trigger a procedure for a release and/or a deregistration and/or a re-registration of the IAB node.

In a fourth aspect of the disclosure, there is provided an IAB donor. The IAB donor comprises a processor and a memory coupled to the processor. Said memory contains instructions executable by said processor. Said IAB donor may be operative to determine that an IAB node is emptied and/or ready to be released and/or deregistered and/or re-registered. Said IAB donor may be further operative to send information that the IAB node is emptied and/or ready to be released and/or deregistered and/or re-registered to a mobility management node. The information that an IAB node is emptied and/or ready to be released and/or deregistered and/or re-registered may be used by the mobility management node to trigger a procedure for a release and/or a deregistration and/or a re-registration of the IAB node.

In a fifth aspect of the disclosure, there is provided a mobility management node. The mobility management node may comprise an obtaining module configured to obtain information that an integrated access and backhaul (IAB) node is emptied and/or ready to be released and/or deregistered and/or re-registered. The mobility management node may further comprise a triggering module configured to trigger a procedure for a release and/or a deregistration and/or a re-registration of the IAB node.

In an embodiment, the mobility management node may further comprise a receiving module configured to receive the information that the IAB node is emptied and/or ready to be released and/or deregistered and/or re-registered from an IAB donor serving the IAB node.

In an embodiment, the mobility management node may further comprise a monitoring module configured to monitor at least one terminal device and/or at least one descendant IAB node and/or at least one child IAB node connected via the IAB node. The information that the IAB node is emptied and/or ready to be released and/or deregistered and/or re-registered may be obtained based on a monitoring result.

In an embodiment, the mobility management node may further comprise a sending module configured to send to an IAB donor serving the IAB node a message informing the IAB donor that the IAB node is no longer authorized to act as IAB node.

In a sixth aspect of the disclosure, there is provided an IAB donor. The IAB donor may comprise a determining module configured to determine that an IAB node is emptied and/or ready to be released and/or deregistered and/or re-registered. The IAB donor may further comprise a sending module configured to send information that the IAB node is emptied and/or ready to be released and/or deregistered and/or re-registered to a mobility management node. The information that an IAB node is emptied and/or ready to be released and/or deregistered and/or re-registered may be used by the mobility management node to trigger a procedure for a release and/or a deregistration and/or a re-registration of the IAB node.

In an embodiment, the IAB donor may further comprise a receiving module configured to receive a message informing the IAB donor that the IAB node is no longer authorized to act as IAB node from the mobility management node.

In another aspect of the disclosure, there is provided a computer-readable storage medium storing instructions which when executed by at least one processor, cause the at least one processor to perform the method according to any one of the first or second aspects.

In another aspect of the disclosure, there is provided a computer program product comprising instructions which when executed by at least one processor, cause the at least one processor to perform the method according to any one of the first or second aspects.

Embodiments herein may provide many advantages, of which a non-exhaustive list of examples follows. In some embodiments herein, it may enable the network to know that the IAB node is ready to be re-registered and/or de-registered and/or released from the network such as 5GS. In some embodiments herein, it may enable the network to trigger the release and/or the deregistration and/or the re-registration of IAB node without impacting the service of UEs and/or descendant IAB nodes and/or child IAB nodes (and their served UEs) connected via the IAB node. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a schematically shows IAB architecture according to an embodiment of the present disclosure;

FIG. 1b schematically shows parent-node and child-node relationship for IAB node according to an embodiment of the present disclosure;

FIG. 1c schematically shows IAB architecture for 5GS according to an embodiment of the present disclosure;

FIG. 2 shows a flowchart of a method according to an embodiment of the present disclosure;

FIG. 3 shows a flowchart of a method according to an embodiment of the present disclosure;

FIG. 4 shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8a is a block diagram showing an apparatus suitable for practicing some embodiments of the disclosure;

FIG. 8b is a block diagram showing a mobility management node according to an embodiment of the disclosure;

FIG. 8c is a block diagram showing an IAB donor according to an embodiment of the disclosure;

FIG. 9 shows an example of a communication system according to an embodiment of the disclosure;

FIG. 10 shows a UE in accordance with some embodiments;

FIG. 11 shows a network node in accordance with some embodiments;

FIG. 12 is a block diagram of a host according to an embodiment of the disclosure;

FIG. 13 is a block diagram illustrating a virtualization environment in which functions implemented by some embodiments may be virtualized; and

FIG. 14 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

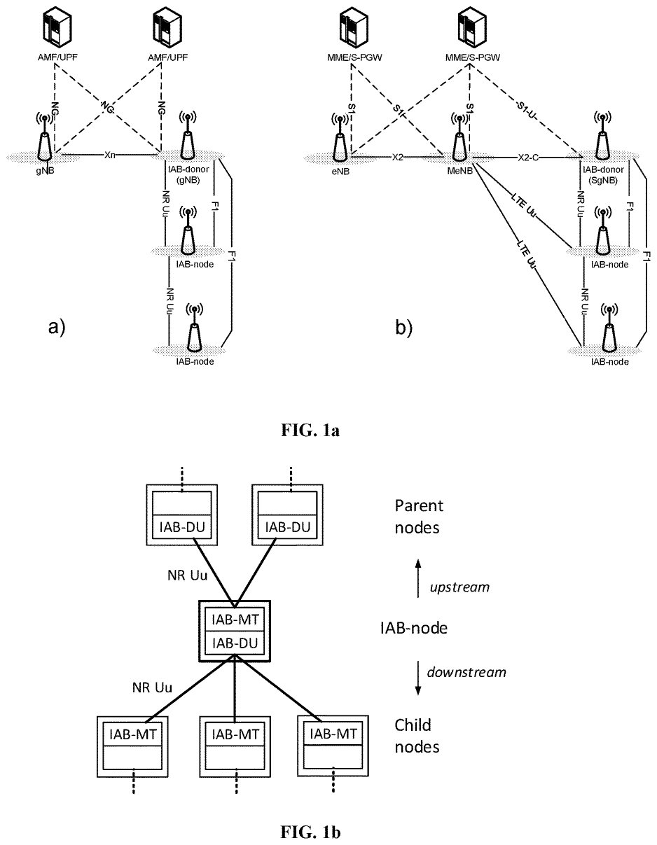

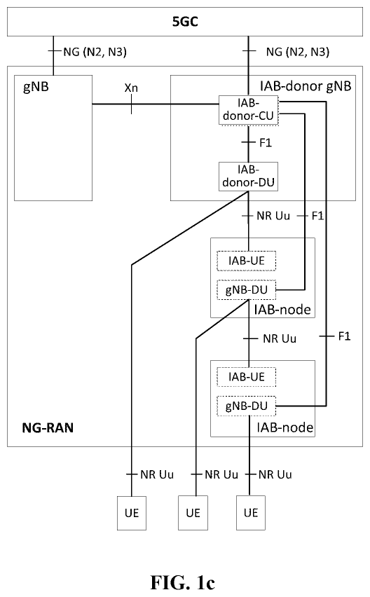

Although the subject matter described herein may be implemented in any appropriate type of system using any suitable components, the embodiments disclosed herein are described in relation to a communication system complied with the exemplary system architectures illustrated in FIG. 1a-1c. For simplicity, the system architectures of FIG. 1a-1c only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

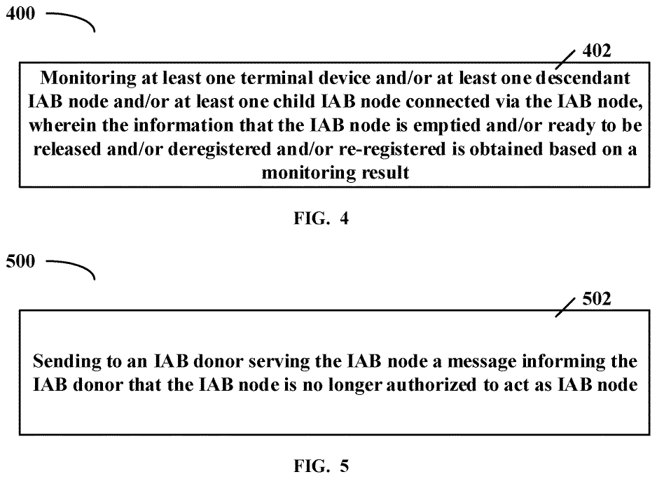

FIG. 1a schematically shows IAB architecture according to an embodiment of the present disclosure, which is the same as FIG. 4.7.1-1 of 3GPP TS 38.300 V17.3.0, the disclosure of which is incorporated by reference herein in its entirety.

The IAB node supports the gNB-DU functionality, as defined in 3GPP TS 38.401 V17.3.0, to terminate the NR access interface to UEs and next-hop IAB nodes, and to terminate the F1 protocol to the gNB-CU functionality, as defined in 3GPP TS 38.401 V17.3.0, on the IAB-donor. The gNB-DU functionality on the IAB node is also referred to as IAB-DU.

In addition to the gNB-DU functionality, the IAB node also supports a subset of the UE functionality referred to as IAB-MT, which includes, e.g., physical layer, layer-2, RRC (Radio Resource Control) and Non-Access-Statum (NAS) functionality to connect to the gNB-DU of another IAB node or the IAB-donor, to connect to the gNB-CU on the IAB-donor, and to the core network.

The IAB node can access the network using either SA (Standalone) mode or EN-DC (E-UTRA-NR Dual Connectivity) as shown in the left figure and the right figure of FIG. 1a respectively. In EN-DC, the IAB node connects via E-UTRA to a MeNB (Master eNodeB), and the IAB-donor terminates X2-C as SgNB (Secondary gNodeB) (see 3GPP TS 37.340 V17.3.0, the disclosure of which is incorporated by reference herein in its entirety).

FIG. 1b schematically shows parent-node and child-node relationship for IAB node according to an embodiment of the present disclosure, which is the same as FIG. 4.7.1-2 of 3GPP TS 38.300 V17.3.0.

All IAB nodes that are connected to an IAB-donor via one or multiple backhaul hops and controlled by this IAB-donor via F1 application protocol (F1AP) and/or RRC form an IAB topology with the IAB-donor as its root. In this IAB topology, the neighbor node of the IAB-DU or the IAB-donor-DU is referred to as the child node and the neighbor node of the IAB-MT is referred to as the parent node. The direction toward the child node is referred to as downstream while the direction toward the parent node is referred to as upstream. The IAB-donor performs centralized resource, topology and route management for its IAB topology.

FIG. 1c schematically shows IAB architecture for 5GS according to an embodiment of the present disclosure, which is the same as FIG. 5.35.1-1 of 3GPP TS 23.501 V18.0.0.

IAB enables wireless in-band and out-of-band relaying of NR Uu access traffic via NR Uu backhaul links. The Uu backhaul links can exist between the IAB node and a gNB referred to as IAB-donor or another IAB node.

The part of the IAB node that supports the Uu interface towards the IAB-donor or another parent IAB node (and thus manages the backhaul connectivity with either PLMN (Public Land Mobile Network) or SNPN (Stand-alone Non-Public Network) it is registered with) is referred to as an IAB-UE.

The IAB may have the following characteristics:
IAB uses the CU/DU architecture defined in 3GPP TS 38.401 V17.3.0, and the IAB operation via F1 (between IAB-donor and IAB node) is invisible to the 5GC (5G Core Network);
IAB performs relaying at layer-2, and therefore does not require a local UPF;
IAB supports multi-hop backhauling;
IAB supports dynamic topology update, i.e. the IAB node can change the parent node, e.g. another IAB node, or the IAB-donor, during operation, for example in response to backhaul link failure or blockage.

The gNB-DU in the IAB node is responsible for providing NR Uu access to UEs and child IAB nodes. The corresponding gNB-CU function resides on the IAB-donor gNB, which controls IAB node gNB-DU via the F1 interface. IAB node appears as a normal gNB to UEs and other IAB nodes and allows them to connect to the 5GC.

The IAB-UE function behaves as a UE, and reuses UE procedures to connect to:
the gNB-DU on a parent IAB node or IAB-donor for access and backhauling;
the gNB-CU on the IAB-donor via RRC for control of the access and backhaul link;
5GC, e.g. AMF, via NAS;
OAM (Operation Administration and Maintenance) system via a PDU (Protocol Data Unit) session or PDN (Packet Data Network) connection (based on implementation).

The IAB-UE can connect to 5GC over NR (SA mode) or connect to EPC (EN-DC mode). The UE served by the IAB node can operate in the same or different modes than the IAB node as defined in 3GPP TS 38.401 V17.3.0. The operation mode with both UE and IAB node connected to EPC (Evolved Packet Core) is covered in 3GPP TS 23.401 V18.0.0. Operation modes with UE and IAB node connected to different core networks are described in clause 5.35.6 of 3GPP TS 23.501 V18.0.0.

IAB node may be stationary or mobile (e.g., can move from one IAB-donor gNB to another IAB-donor gNB).

FIG. 2 shows a flowchart of a method according to an embodiment of the present disclosure, which may be performed by an apparatus implemented in or at or as a mobility management node or communicatively coupled to the mobility management node. As such, the apparatus may provide means or modules for accomplishing various parts of the method 200 as well as means or modules for accomplishing other processes in conjunction with other components.

The mobility management node may be any suitable network function which can implement mobility management function. In an embodiment, the mobility management node may implement access management function.

In an embodiment, the mobility management node may comprise at least one of an access and mobility management function (AMF) or a mobile management entity (MME).

In an embodiment, the mobility management node may be AMF or MME for example as shown in FIG. 1a.

At block 202, the mobility management node may obtain information that an integrated access and backhaul (IAB) node is emptied and/or ready to be released and/or deregistered and/or re-registered.

The IAB node may be any suitable node that supports access links to terminal devices and backhaul links to parent nodes and child nodes. For example, the IAB node may be a radio node that supports NR access links to UEs and NR backhaul links to parent nodes and child nodes.

The IAB node may be a relay node that supports wireless in-band and out-of-band relaying of access traffic via Uu backhaul links. It may support the UE function and the DU function of the CU/DU architecture for IAB defined in 3GPP TS 38.401 V17.3.0.

In an embodiment, the IAB node may be the corresponding IAB node as described in various 3GPP specifications such as 3GPP TS 38.401 V17.3.0, 3GPP TS 38.300 V17.3.0, 3GPP TS 23.401 V18.0.0, 3GPP TS 23.501 V18.0.0, 3GPP TS 23.502 V18.0.0, etc.

The IAB node is emptied and/or ready to be released and/or deregistered and/or re-registered may be defined in various ways. For example, when the IAB node does not serve any terminal device and/or any descendant IAB node and/or any child IAB node, the IAB node may be emptied and/or ready to be released and/or deregistered and/or re-registered. When the IAB node does not serve a specific terminal device and/or a specific descendant IAB node and/or a specific child IAB node, the IAB node may be emptied and/or ready to be released and/or deregistered and/or re-registered. When all terminal devices and/or all descendant IAB nodes and/or all child IAB nodes connected via the IAB node are moved or handed over to at least one other cell and/or served by at least one other IAB node or other radio access network (RAN) node or released, the IAB node may be emptied and/or ready to be released and/or deregistered and/or re-registered. When a specific terminal device and/or a specific descendant IAB node and/or a specific child IAB node connected via the IAB node is moved or handed over to at least one other cell and/or served by at least one other IAB node or other radio access network (RAN) node or released, the IAB node may be emptied and/or ready to be released and/or deregistered and/or re-registered.

In an embodiment, the information that the IAB node is emptied and/or ready to be released and/or deregistered and/or re-registered may indicate at least one of the IAB node does not serve any terminal device and/or any descendant IAB node and/or any child IAB node, or all terminal devices and/or all descendant IAB nodes and/or all child IAB nodes connected via the IAB node are moved or handed over to at least one other cell and/or served by at least one other IAB node or other radio access network (RAN) node or released, or a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.

In an embodiment, the term “child IAB node” may refer to an IAB node that is served directly by the IAB node. For example, the child IAB node may refer to IAB-DU's and IAB-donor-DU's next hop neighbor node. The child IAB node may be also an IAB node.

In an embodiment, the term “descendant IAB node” may refer to an IAB node that is served indirectly by the IAB node. For example, the descendant IAB node may be served by its child nodes or by the child nodes of child nodes of the IAB node and so on.

In an embodiment, the term “parent IAB node” may refer to IAB-MT's next hop neighbor node. The parent IAB node can be IAB node or IAB-donor-DU.

In an embodiment, the mobility management node may obtain information indicating the IAB node does not serve any terminal device and/or any descendant IAB node and/or any child IAB node.

In an embodiment, the mobility management node may obtain information indicating all terminal devices and/or all descendant IAB nodes and/or all child IAB nodes connected via the IAB node are moved or handed over to at least one other cell and/or served by at least one other IAB node or other RAN node or released.

In an embodiment, the mobility management node may obtain information indicating that a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.

The mobility management node may obtain the information that the IAB node is emptied and/or ready to be released and/or deregistered and/or re-registered due to various reasons and the present disclosure has no limit on it. For example, when the network needs to trigger the release and/or the deregistration and/or the re-registration of IAB node (or mobile base station relay) in the network due to different reasons (e.g. subscription data update which leads to the de-authorization of the IAB node acting as IAB node), the mobility management node may obtain the information that the IAB node is emptied and/or ready to be released and/or deregistered and/or re-registered. As another example, when the network node (such as IAB donor) or the IAB node determine that the IAB node is emptied and/or ready to be released and/or deregistered and/or re-registered, it may send the information that the IAB node is emptied and/or ready to be released and/or deregistered and/or re-registered to the mobility management node in response to a request or event subscription from the mobility management node or when a condition (such as the IAB node is no longer authorized to act as IAB node, or the network or the IAB node needs to trigger the release and/or the deregistration and/or the re-registration of IAB node in the network) is met.

In an embodiment, the mobility management node may obtain the information that the IAB node is emptied and/or ready to be released and/or deregistered and/or re-registered in various ways. For example, the mobility management node may obtain the information that the IAB node is emptied and/or ready to be released and/or deregistered and/or re-registered by itself and/or from a network node (such as IAB donor) and/or from the IAB node, etc.

For example, the mobility management node may monitor and determine that the IAB node is emptied and/or ready to be released and/or deregistered and/or re-registered. The network node (such as IAB donor) may monitor and determine that the IAB node is emptied and/or ready to be released and/or deregistered and/or re-registered. The IAB node may know the IAB node is emptied and/or ready to be released and/or deregistered and/or re-registered.

At block 204, the mobility management node may trigger a procedure for a release and/or a deregistration and/or a re-registration of the IAB node.

In an embodiment, when the IAB node is emptied and/or ready to be released and/or deregistered and/or re-registered, the mobility management node may trigger the procedure for the release and/or the deregistration and/or the re-registration of the IAB node.

In an embodiment, when the network needs to trigger the release and/or the deregistration and/or the re-registration of the IAB node and the IAB node is emptied and/or ready to be released and/or deregistered and/or re-registered, the mobility management node may trigger the procedure for the release and/or the deregistration and/or the re-registration of the IAB node.

In an embodiment, when the IAB node or the IAB donor requires the release and/or deregistration and/or re-registration of IAB node and the IAB node is emptied and/or ready to be released and/or deregistered and/or re-registered, the mobility management node may trigger the procedure for the release and/or the deregistration and/or the re-registration of the IAB node.

The procedure for the release and/or the deregistration and/or the re-registration of the IAB node may be any suitable procedure. For example, according to clause 8.9.10 of 3GPP TS 38.401 V17.3.0, the IAB-donor-CU can remove the F1 interface connection to the IAB-DU without releasing the IAB-MT. If the IAB-MT needs to be released, IAB-MT will perform the deregistration procedure. If both F1 interface and IAB-MT need to be released, the IAB-donor-CU should remove the F1 interface to the IAB-DU before it releases the collocated IAB-MT. The deregistration procedure is the same as the UE deregistration procedure. The IAB-donor-CU hands over the UEs or child IAB nodes currently connected to the IAB node's cell(s) to another cell(s), or releases the UEs and may stop accepting incoming handovers or connections to the IAB node that is about to be released. The IAB-donor-CU may also update/release the BH RLC channels in the intermediate hops. At this point, the F1 interface will be released and the corresponding SCTP associations will be removed.

In an embodiment, the mobility management node such as AMF/MME serving the IAB node, may trigger the IAB node re-registration, e.g. via NAS UE Configuration Update procedure or NAS deregistration procedure with re-registration required e.g. as described in 3GPP TS 23.502 V18.0.0.

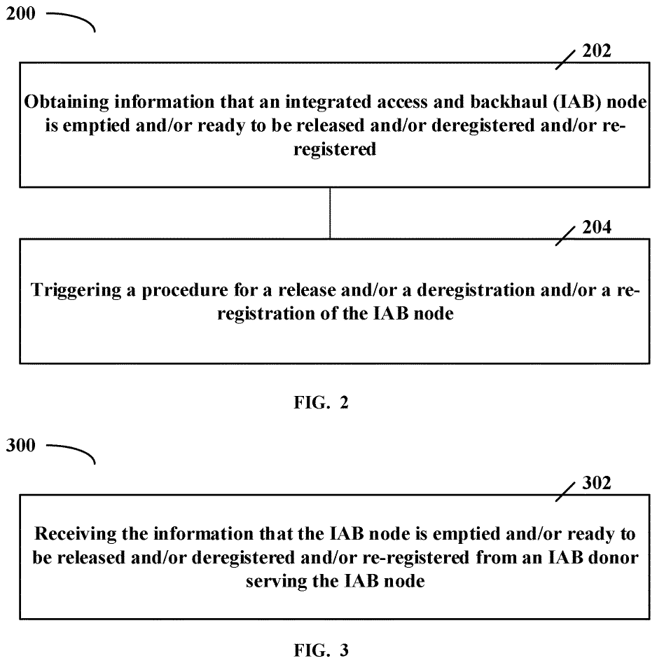

FIG. 3 shows a flowchart of a method according to another embodiment of the present disclosure, which may be performed by an apparatus implemented in or at or as a mobility management node or communicatively coupled to the mobility management node. As such, the apparatus may provide means or modules for accomplishing various parts of the method 300 as well as means or modules for accomplishing other processes in conjunction with other components. For some parts which have been described in the above embodiments, the description thereof is omitted here for brevity.

At block 302, the mobility management node may receive the information that the IAB node is emptied and/or ready to be released and/or deregistered and/or re-registered from an IAB donor serving the IAB node.

The IAB donor may be a network node such as gNB that provides network access to UEs via a network of backhaul and access links.

In an embodiment, the IAB donor may be the IAB donor as described in various 3GPP specifications such as 3GPP TS 38.401 V17.3.0, 3GPP TS 38.300 V17.3.0, 3GPP TS 23.401 V18.0.0, 3GPP TS 23.501 V18.0.0, 3GPP TS 23.502 V18.0.0, etc.

As an example, the IAB donor (e.g. gNB/eNB/base station) may know the connected IAB nodes (e.g., the IAB node). It may also know which UE is connected via the IAB node or child IAB node or descendant IAB node. For example, as shown in FIG. 1c, the donor-CU parts in the IAB donor may manage all the IAB-DUs/Cells of the IAB node via F1 interface. The mobility management node may monitor the number of UEs and descendant and child IAB nodes connected and descendant IAB nodes via the IAB node. When the number of UEs and descendant and child IAB nodes connected via the IAB node is zero, the IAB donor may determine that the IAB node is emptied and/or ready to be released and/or deregistered and/or re-registered. Then the IAB donor may send the information that the IAB node is emptied and/or ready to be released and/or deregistered and/or re-registered to the mobility management node for example when the IAB node is no longer authorized to act as IAB node or the RAN (such as the IAB donor) requests a release of the IAB node from the network.

As a second example, the IAB donor (e.g. gNB/eNB) may know the connected IAB nodes. It may also know which UE is connected via the IAB node or child IAB nodes or descendant IAB nodes. As shown in FIG. 1c, the donor-CU parts in the IAB donor may manage all the IAB-DUs/Cells of the IAB node via F1 interface. The IAB-donor-CU may try to hand over or move the UEs and/or child IAB nodes and/or descendant IAB node currently connected to the IAB node's cell(s) to another cell(s), or release the UEs and/or child IAB nodes and/or descendant IAB node and may stop accepting incoming handovers or connections to the IAB node that is about to be released. The IAB-donor-CU may indicate to AMF/MME that the IAB node serves no UEs and descendant/child IAB nodes anymore (which may be referred to as the “IAB node emptied and/or ready to be released and/or deregistered and/or re-registered” indication).

The information that the IAB node is emptied and/or ready to be released and/or deregistered and/or re-registered may be of any suitable form such as a bit, a flag, an information element, an indication, an indicator, a parameter, or a value, a cause value, etc.

The information that the IAB node is emptied and/or ready to be released and/or deregistered and/or re-registered may be comprised in any suitable message such as existing message or new message. For example, the existing message may be any suitable existing message as described in various 3GPP specifications such as 3GPP TS 38.401 V17.3.0, 3GPP TS 38.300 V17.3.0, 3GPP TS 23.401 V18.0.0, 3GPP TS 23.501 V18.0.0, 3GPP TS 23.502 V18.0.0, etc. In an embodiment, the information that the IAB node is emptied and/or ready to be released and/or deregistered and/or re-registered may be received from the IAB donor serving the IAB node in a next generation application protocol message or an S1 application protocol message. For example, this information can either be carried in an existing NGAP(Next Generation Application Protocol)/S1AP (S1 Application Protocol) message (such as existing UE Context Release Request message) as described in various 3GPP specifications or a new NGAP/S1AP message.

In an embodiment, the information that the IAB node is emptied and/or ready to be released and/or deregistered and/or re-registered may be received from the IAB donor serving the IAB node in a user equipment context release request e.g. as described in 3GPP TS 38.413 V17.3.0, the disclosure of which is incorporated by reference herein in its entirety.

In an embodiment, the information that the IAB node is emptied and/or ready to be released and/or deregistered and/or re-registered may be received from the IAB donor serving the IAB node in a cause parameter e.g. Radio Network Layer Cause as described in clause 9.3.1.2 of 3GPP TS 38.413 V17.3.0. The cause parameter may be added with a cause value indicating the IAB node is emptied and/or ready to be released and/or deregistered and/or re-registered, e.g., IAB node emptied and/or ready to be released and/or deregistered and/or re-registered. The IAB node emptied and/or ready to be released and/or deregistered and/or re-registered may indicate a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.

In an embodiment, the information that the IAB node is emptied and/or ready to be released and/or deregistered and/or re-registered may comprise at least one of single information indicating that the IAB node no longer serves a terminal device and a descendant IAB node and a child IAB node, or first information indicating that the IAB node no longer serves a terminal device and/or second information indicating that the IAB node no longer serves a descendant IAB node and/or a child IAB node.

In an embodiment, after receiving the information that the IAB node is emptied and/or ready to be released and/or deregistered and/or re-registered from an IAB donor serving the IAB node, block 202 and/or block 204 of FIG. 2 may be performed.

FIG. 4 shows a flowchart of a method according to another embodiment of the present disclosure, which may be performed by an apparatus implemented in or at or as a mobility management node or communicatively coupled to the mobility management node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the mobility management node may monitor at least one terminal device and/or at least one descendant IAB node and/or at least one child IAB node connected via the IAB node.

In an embodiment, the information that the IAB node is emptied and/or ready to be released and/or deregistered and/or re-registered may be obtained based on a monitoring result.

For example, the mobility management node may monitor the number of UEs and descendant and child IAB nodes connected via the IAB node. When the number of UEs and descendant and child IAB nodes connected via the IAB node is zero, the mobility management node may determine that the IAB node is emptied and/or ready to be released and/or deregistered and/or re-registered.

For example, the mobility management node such as AMF/MME may obtain IAB topology information by itself or from another network node such as the IAB donor. The IAB topology information may comprise for example which UEs are connected via the IAB node, which child IAB nodes are connected via the IAB node, which descendant IAB nodes are connected via the IAB node, which UEs are connected via the descendant IAB nodes, which UEs are connected via the child IAB nodes, etc. When a UE or IAB node is connected to the network or released/de-registered from the network or handed over to another cell, the mobility management node may monitor this event and can update the IAB topology information. When the number of UEs and descendant and child IAB nodes connected via the IAB node is zero, the mobility management node may determine that the IAB node is emptied and/or ready to be released and/or deregistered and/or re-registered.

In an embodiment, the mobility management node such as AMF/MME may obtain IAB topology information by itself based on ULI (user location information). For example, when a UE is connected via a IAB-DU/cell, the network node such as gNB may provide ULI to mobility management node such as AMF/MME. The ULI may include the cell identifier (ID) of the IAB-DU (e.g. an indication that this cell ID is managed by an IAB-DU). Then the mobility management node such as AMF/MME may obtain the IAB topology information based on ULI.

In an embodiment, block 402 may be performed when the IAB node, one or more terminal devices served by the IAB node, one or more descendant IAB nodes of the IAB node and one or more terminal devices served by the descendant IAB nodes are served by a same mobility management node.

The mobility management node such as AMF/MME may know all child/descendant IAB nodes and UEs served by the IAB node are connected to the same mobility management node in various ways. For example, it may be based on a setting/configuration from the operator if such mobility management node based monitoring logic can be applied (e.g. the operator may know that in this area/city, there is only one mobility management node such as AMF/MME and all UEs/IAB nodes will be connected to this one mobility management node such as AMF/MME).

In an embodiment, when the IAB node, one or more terminal devices served by the IAB node, one or more descendant IAB nodes of the IAB node and one or more terminal devices served by the descendant IAB nodes are served by a same mobility management node and when all terminal devices served by the IAB node and all child IAB nodes of the IAB node have been handed over or moved to at least one other cell or served by at least one other IAB node or other RAN node or released, the procedure for the release and/or the deregistration and/or the re-registration of the IAB node may be triggered.

In an embodiment, when the IAB node, one or more terminal devices served by the IAB node, one or more descendant IAB nodes of the IAB node and one or more terminal devices served by the descendant IAB nodes are served by a same mobility management node and when all terminal devices served by the IAB node and all child IAB nodes of the IAB node have been handed over or moved to at least one other cell or served by at least one other IAB node or other RAN node or released, the mobility management node may determine the IAB node is emptied and/or ready to be released and/or deregistered and/or re-registered.

In an embodiment, for the case when the mobility management node such as AMF/MME applies the monitoring logic, it may still be necessary that the IAB donor such as RAN indicates to the mobility management node such as AMF/MME that no more child/descendant IAB nodes are served (while the mobility management node such as AMF/MME can by itself realize that all UEs served by the IAB node are handed over elsewhere). This is because the mobility management node such as AMF/MME may not know the IAB network topology, i.e., which node is a parent of which IAB node, or it may be because child/descendant nodes of the IAB node are connected to other mobility management nodes such as AMFs/MMEs.

In an embodiment, for the case when the mobility management node such as AMF/MME applies the monitoring logic, if all child/descendants and UEs served by the IAB node are connected to the same mobility management node such as AMF/MME, the mobility management node such as AMF/MME can also use the monitoring logic to conclude that the child/descendant nodes of the IAB node have been handed over. For example, if the IAB network below the IAB node consists of multiple hops, it is likely that that “leaf” descendant IAB nodes of the IAB node (i.e., the nodes furthest downstream from the IAB node, e.g., the nodes that only serve UEs) are the first ones to be handed over to new cells or parent nodes, followed by the handover of the (old) parent nodes of the leaf nodes and so on, until the immediate child nodes of the IAB node are handed over. Hence, in addition to knowing that the UEs served by the IAB node have been handed over, it is sufficient that the mobility management node such as AMF/MME knows that the child nodes have been handed over elsewhere, for the mobility management node such as AMF/MME to conclude that it may now trigger IAB node re-registration, as described above. In other words, no knowledge about the handover of “grandchild” nodes is needed at the mobility management node such as AMF/MME, since they will likely be handed over before the child nodes.

FIG. 5 shows a flowchart of a method according to another embodiment of the present disclosure, which may be performed by an apparatus implemented in or at or as a mobility management node or communicatively coupled to the mobility management node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the mobility management node may send to an IAB donor serving the IAB node a message informing the IAB donor that the IAB node is no longer authorized to act as IAB node.

For example, when the network needs to trigger the release of IAB node (or mobile base station relay) in the network due to different reasons (e.g. subscription data update which leads to the de-authorization of the IAB node acting as IAB node), block 502 may be performed.

In an embodiment, block 202 of FIG. 2 or block 302 of FIG. 3 or block 402 of FIG. 4 may be performed after block 502.

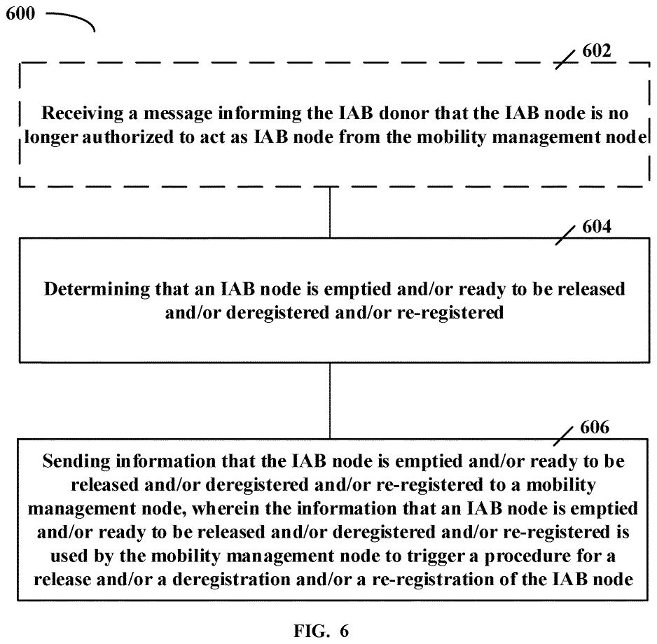

FIG. 6 shows a flowchart of a method according to another embodiment of the present disclosure, which may be performed by an apparatus implemented in or at or as an IAB donor or communicatively coupled to the IAB donor. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, optionally, the IAB donor may receive a message informing the IAB donor that the IAB node is no longer authorized to act as IAB node from the mobility management node.

At block 604, the IAB donor may determine that an IAB node is emptied and/or ready to be released and/or deregistered and/or re-registered.

In an embodiment, when the IAB node does not serve any terminal device and/or any descendant IAB node and/or any child IAB node, the IAB node may be determined as emptied and/or ready to be released and/or deregistered and/or re-registered.

In an embodiment, when all terminal devices and/or all descendant IAB nodes and/or all child IAB nodes connected via the IAB node are moved or handed over to at least one other cell and/or served by at least one other IAB node or other RAN node or released, the IAB node may be determined as emptied and/or ready to be released and/or deregistered and/or re-registered.

In an embodiment, when at least one specific terminal device and/or at least one specific descendant IAB node and/or at least one specific child IAB node connected via the IAB node is moved or handed over to at least one other cell and/or served by at least one other IAB node or other RAN node or released, the IAB node may be determined as emptied and/or ready to be released and/or deregistered and/or re-registered.

For example, the RAN node serving the IAB node may try to move or hand over the UEs and its descendant/child IAB nodes (and their served UEs) connected via the IAB node to other cells. In an embodiment, the RAN node may release the UEs and its descendant/child IAB nodes (and their served UEs) connected via the IAB node when they cannot be moved or handed over. When the IAB node does not serve any terminal device and/or any descendant IAB node and/or any child IAB node, the IAB donor may determine that an IAB node is emptied and/or ready to be released and/or deregistered and/or re-registered.

At block 606, the IAB donor may send information that the IAB node is emptied and/or ready to be released and/or deregistered and/or re-registered to a mobility management node.

In an embodiment, the mobility management node comprises at least one of an AMF, or an MME.

In an embodiment, the information that an IAB node is emptied and/or ready to be released and/or deregistered and/or re-registered may be used by the mobility management node to trigger a procedure for a release and/or a deregistration and/or a re-registration of the IAB node.

In an embodiment, the information that the IAB node is emptied and/or ready to be released and/or deregistered and/or re-registered may indicate at least one of the IAB node does not serve any terminal device and/or any descendant IAB node and/or any child IAB node, or all terminal devices and/or all descendant IAB nodes and/or all child IAB nodes connected via the IAB node are moved or handed over to at least one other cell and/or served by at least one other IAB node or other RAN node or released, or a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.

In an embodiment, the information that the IAB node may comprise at least one of single information indicating that the IAB node no longer serves a terminal device and a descendant IAB node and a child IAB node, or first information indicating that the IAB node no longer serves a terminal device and/or second information indicating that the IAB node no longer serves a descendant IAB node and/or a child IAB node.

In an embodiment, the information that the IAB node is emptied and/or ready to be released and/or deregistered and/or re-registered may be sent to the mobility management node in next generation application protocol message or an S1 application protocol message.

In an embodiment, the information that the IAB node is emptied and/or ready to be released and/or deregistered and/or re-registered may be comprised in a user equipment context release request or in a cause parameter. The cause parameter may be added with a cause value indicating the IAB node is emptied and/or ready to be released and/or deregistered and/or re-registered.

In an embodiment, when an IAB donor such as donor-IAB-CU (e.g., donor-gNB/donor-eNB) has moved or handed over all connected UEs to other cells or released all connected UEs, i.e., there are no more UEs and descendant/child IAB nodes served by cells configured on the IAB node, the IAB donor such as donor-IAB-CU (e.g., donor-gNB/donor-eNB) may trigger a signaling towards the mobility management node such as AMF/MME that serves the IAB node indicating that the IAB node is ready for release and/or deregistration and/or re-registration.

In an embodiment, the mobility management node such as AMF/MME may develop a logic to monitor the number of UEs and descendant and child IAB nodes connected via the IAB node/cell when it decides that IAB node is no longer authorized to act as IAB node (e.g., due to subscription data change) and it can inform RAN with the IAB donor function (i.e., the IAB donor serving the IAB node). This logic may work when the IAB node and its served UEs and child/descendant IAB nodes, and the UEs served by these child/descendant IAB node nodes connected via IAB node are served by the same mobility management node such as AMF/MME.

In an embodiment, it may provide means for the network to trigger the release and/or the deregistration and/or the re-registration of IAB node without impacting the service of UEs and descendant/child IAB nodes (and their served UEs) connected via the IAB node.

FIG. 7 shows a flowchart of a method 700 according to another embodiment of the present disclosure.

When the network needs to trigger the release and/or the deregistration and/or the re-registration of IAB node (or mobile base station relay) in the network due to different reasons (e.g. subscription data update which leads to the de-authorization of the IAB node acting as IAB node), the following steps may take place.

At step 702. The mobility management node such as AMF/MME may use the NGAP/S1AP message (e.g., UE Context Modification Request) to inform RAN node (i.e., the donor CU serving the IAB node) that the IAB node is no longer authorized to act as IAB node (e.g. set the “IAB authorized” parameter to value “not authorized”).

At step 704. The RAN node serving the IAB node may try to move or hand over the UEs and its descendant/child IAB nodes (and their served UEs) connected via the IAB node to other cells. In an embodiment, the RAN node may release the UEs and its descendant/child IAB nodes (and their served UEs) connected via the IAB node when they cannot be moved or handed over.

At step 706. The RAN node may indicate to the mobility management node such as AMF/MME that the IAB node serves no UEs and/or descendant/child IAB nodes anymore (e.g., the “IAB node emptied and/or ready to be released and/or deregistered and/or re-registered” indication). This indication can either be carried in an existing NGAP/S1AP message (e.g., existing UE Context Release Request message) or a new NGAP/S1AP message.

In an embodiment, there may be a single “IAB node emptied and/or ready to be released and/or deregistered and/or re-registered” indication, indicating that the IAB node no longer serves UEs and/or child/descendant IAB nodes. In another embodiment, there may be such a separate indication for UEs served by the IAB node and such a separate indication for the child/descendant nodes of the IAB node.

In an embodiment, it's also possible to send the indication in different way (e.g., a new parameter, or a new value in the cause).

At step 708. The mobility management node such as AMF/MME, which serves the IAB node, may trigger the IAB node release and/or deregistration and/or re-registration e.g. via NAS UE Configuration Update procedure or NAS deregistration procedure with re-registration required. This may be performed either after receiving the indication from RAN in step 703 or based on the monitoring logic triggered after step 701. For example, the mobility management node such as AMF/MME may monitor the number of UEs and child/descendant IAB nodes connected via the IAB node (the cell that supported by the IAB node) until there is no more UEs connected.

In an embodiment, for the case when the mobility management node such as AMF/MME applies the monitoring logic, it may still be necessary that the RAN indicates to the mobility management node such as AMF/MME that no more child/descendant IAB nodes are served by the IAB node (while the mobility management node such as AMF/MME can by itself realize that all UEs served by the IAB node are handed over elsewhere). This is because the mobility management node such as AMF/MME may not know the IAB network topology, i.e., which node is a parent of which IAB node, or it may be because child/descendant nodes of the IAB node are connected to other mobility management node such as AMFs/MMEs.

In an embodiment, if all child/descendants and UEs served by the IAB node are connected to the same mobility management node such as AMF/MME, the mobility management node such as AMF/MME can also use the monitoring logic to conclude that the child/descendant nodes of the IAB node have been handed over or the IAB node is emptied and/or ready to be released and/or deregistered and/or re-registered. For example, if the IAB network below the IAB node consists of multiple hops, it is likely that that “leaf” descendant IAB nodes of the IAB node (i.e., the nodes furthest downstream from the IAB node, e.g., the nodes that only serve UEs) are the first ones to be handed over to new parent nodes, followed by the handover of the (old) parent nodes of the leaf nodes and so on, until the immediate child nodes of the IAB node are handed over. Hence, in addition to knowing that the UEs served by the IAB node have been handed over, it is sufficient that the mobility management node such as AMF/MME knows that the child nodes have been handed over elsewhere, for the mobility management node such as AMF/MME to conclude that it may now trigger IAB node release and/or deregistration and/or re-registration, as described above. In other words, no knowledge about the handover of “grandchild” nodes is needed at the mobility management node such as AMF/MME, since they will likely be handed over before the child nodes.

In an embodiment, clause 9.2.2.4 of 3GPP TS 38.413 V17.3.0 may be amended as following.

### 9.2.2.4 UE Context Release Request

This message is sent by the NG-RAN (next generation RAN) node to request the release of the UE-associated logical NG-connection over the NG interface.

### Direction: NG-RAN Node→AMF

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| AMF UE NGAP ID | M | | 9.3.3.1 | | YES | reject |
| RAN UE NGAP ID | M | | 9.3.3.2 | | YES | reject |
| PDU Session | | 0 . . . 1 | | | YES | reject |
| Resource List | | | | | | |
| >PDU Session | | 1 . . . <maxnoofPDUSessions> | | | — | |
| Resource Item | | | | | | |
| >>PDU Session ID | M | | 9.3.1.50 | | — | |
| Cause | M | | 9.3.1.2 | | YES | ignore |
| IAB node emptied | O | | x.x.x | | YES | ignore |
| and/or ready to be | | | | | | |
| released and/or | | | | | | |
| deregistered and/or | | | | | | |
| re-registered | | | | | | |

Note that the IE “IAB node emptied and/or ready to be released and/or deregistered and/or re-registered” may be replaced by any other suitable IE with the similar/same meanings.

In an embodiment, a new Cause value is added to indicated that IAB node is emptied and/or ready to be released and/or deregistered and/or re-registered, i.e., that it does not serve any more UEs and child/descendant IAB nodes.

In an embodiment, clause 9.3.1.2 of 3GPP TS 38.413 V17.3.0 may be amended as following.

### Cause 9.3.1.2

The purpose of the Cause IE is to indicate the reason for a particular event for the NGAP protocol.

| | | | | |
|---|---|---|---|---|
| | | | | Semantics |
| IE/Group Name | Presence | Range | IE type and reference | description |

| | | |
|---|---|---|
| CHOICE Cause | M | |
| Group | | |
| >Radio Network | | |
| Layer | | |
| >>Radio Network | M | ENUMERATED |
| Layer Cause | | (Unspecified, |
| | | TXnRELOCOverall expiry, |
| | | Successful handover, |
| | | Release due to NG-RAN |
| | | generated reason, |
| | | Release due to 5GC |
| | | generated reason, |
| | | Handover cancelled, |
| | | Partial handover, |
| | | Handover failure in target |
| | | 5GC/NG-RAN node or target |
| | | system, |
| | | Handover target not allowed, |
| | | TNGRELOCoverall expiry, |
| | | TNGRELOCprep expiry, |
| | | Cell not available, |
| | | Unknown target ID, |
| | | No radio resources available |
| | | in target cell, |
| | | Unknown local UE NGAP |
| | | ID, |
| | | Inconsistent remote UE |
| | | NGAP ID, |
| | | Handover desirable for radio |
| | | reasons, |
| | | Time critical handover, |
| | | Resource optimisation |
| | | handover, |
| | | Reduce load in serving cell, |
| | | User inactivity, |
| | | Radio connection with UE |
| | | lost, |
| | | Radio resources not |
| | | available, |
| | | Invalid QoS combination, |
| | | Failure in the radio interface |
| | | procedure, |
| | | Interaction with other |
| | | procedure, |
| | | Unknown PDU Session ID, |
| | | Unknown QoS Flow ID, |
| | | Multiple PDU Session ID |
| | | Instances, |
| | | Multiple QoS Flow ID |
| | | Instances, |
| | | Encryption and/or integrity |
| | | protection algorithms not |
| | | supported, |
| | | NG intra-system handover |
| | | triggered, |
| | | NG inter-system handover |
| | | triggered, |
| | | Xn handover triggered, |
| | | Not supported 5QI value, |
| | | UE context transfer, |
| | | IMS voice EPS fallback or |
| | | RAT fallback triggered, |
| | | UP integrity protection not |
| | | possible, |
| | | UP confidentiality protection |
| | | not possible, |
| | | Slice(s) not supported, |
| | | UE in RRC_INACTIVE state |
| | | not reachable, |
| | | Redirection, |
| | | Resources not available for |
| | | the slice(s), |
| | | UE maximum integrity |
| | | protected data rate reason, |
| | | Release due to CN-detected |
| | | mobility, . . . , |
| | | N26 interface not |
| | | available, Release due to |
| | | pre-emption, Multiple |
| | | Location Reporting |
| | | Reference ID Instances, |
| | | RSN not available for the UP, |
| | | NPN access denied, |
| | | CAG only access denied, |
| | | Insufficient UE Capabilities, |
| | | RedCap UE not supported, |
| | | Unknown MBS Session ID, |
| | | Indicated MBS Session Area |
| | | Information not served by the |
| | | gNB, |
| | | Inconsistent slice info for the |
| | | session, |
| | | Misaligned association for |
| | | the multicast and unicast |
| | | sessions or flows, IAB node |
| | | emptied and/or ready to be |
| | | released and/or deregistered |
| | | and/or re-registered) |
| >Transport Layer | | |
| >>Transport Layer | M | ENUMERATED |
| Cause | | (Transport resource |
| | | unavailable, |
| | | Unspecified, . . . ) |
| >NAS | | |
| >>NAS Cause | M | ENUMERATED |
| | | (Normal release, |
| | | Authentication failure, |
| | | Deregister, |
| | | Unspecified, . . . , |
| | | UE not in PLMN serving |
| | | area) |
| >Protocol | | |
| >>Protocol Cause | M | ENUMERATED |
| | | (Transfer syntax error, |
| | | Abstract syntax error (reject), |
| | | Abstract syntax error (ignore |
| | | and notify), |
| | | Message not compatible with |
| | | receiver state, |
| | | Semantic error, |
| | | Abstract syntax error (falsely |
| | | constructed message), |
| | | Unspecified, . . . ) |
| >Miscellaneous | | |
| >>Miscellaneous | M | ENUMERATED |
| Cause | | (Control processing overload, |
| | | Not enough user plane |
| | | processing resources, |
| | | Hardware failure, |
| | | O&M intervention, |
| | | Unknown PLMN or SNPN, |
| | | Unspecified, . . . ) |

The meaning of the different cause values is described in the following tables. In general, “not supported” cause values indicate that the related capability is missing. On the other hand, “not available” cause values indicate that the related capability is present, but insufficient resources were available to perform the requested action.

| Radio Network Layer cause | Meaning |
|---|---|
| Unspecified | Sent for radio network layer cause when none of the specified |
| | cause values applies. |
| TXnRELOCOverall expiry | The timer guarding the handover that takes place over Xn has |
| | abnormally expired. |
| Successful handover | Successful handover. |
| Release due to NG-RAN | Release is initiated due to NG-RAN generated reason. |
| generated reason | |
| Release due to 5GC generated | Release is initiated due to 5GC generated reason. |
| reason | |
| Handover cancelled | The reason for the action is cancellation of Handover. |
| Partial handover | Provides a reason for the handover cancellation. The |
| | HANDOVER COMMAND message from AMF contained PDU |
| | Session Resource to Release List IE or QoS flow to Release List |
| | and the source NG-RAN node estimated service continuity for the |
| | UE would be better by not proceeding with handover towards this |
| | particular target NG-RAN node. |
| Handover failure in target | The handover failed due to a failure in target 5GC/NG-RAN node |
| 5GC/NG-RAN node or target | or target system. |
| system | |
| Handover target not allowed | Handover to the indicated target cell is not allowed for the UE in |
| | question. |
| TNG_{RELOCoverall} expiry | The reason for the action is expiry of timer TNG_{RELOCoverall}. |
| TNG_{RELOCprep} expiry | Handover Preparation procedure is cancelled when timer |
| | TNG_{RELOCprep} expires. |
| Cell not available | The concerned cell is not available. |
| Unknown target ID | Handover rejected because the target ID is not known to the AMF. |
| No radio resources available | Load on target cell is too high. |
| in target cell | |
| Unknown local UE NGAP ID | The action failed because the receiving node does not recognise |
| | the local UE NGAP ID. |
| Inconsistent remote UE | The action failed because the receiving node considers that the |
| NGAP ID | received remote UE NGAP ID is inconsistent. |
| Handover desirable for radio | The reason for requesting handover is radio related. |
| reasons | |
| Time critical handover | Handover is requested for time critical reason i.e., this cause value |
| | is reserved to represent all critical cases where the connection is |
| | likely to be dropped if handover is not performed. |
| Resource optimisation | The reason for requesting handover is to improve the load |
| handover | distribution with the neighbour cells. |
| Reduce load in serving cell | Load on serving cell needs to be reduced. When applied to |
| | handover preparation, it indicates the handover is triggered due to |
| | load balancing. |
| User inactivity | The action is requested due to inactivity on all user data radio |
| | bearers (i.e., DRBs and, if applicable, MRBs as per section |
| | 16.10.5.2 in TS 38.300 [8]), e.g., NG is requested to be released in |
| | order to optimise the radio resources. For L2 U2N Relay UE, this |
| | action is requested due to user inactivity on all PDU sessions of L2 |
| | U2N Relay UE and its served remote UE(s). |
| Radio connection with UE | The action is requested due to losing the radio connection to the |
| lost | UE. |
| Radio resources not available | No requested radio resources are available. |
| Invalid QoS combination | The action was failed because of invalid QoS combination. |
| Failure in the radio interface | Radio interface procedure has failed. |
| procedure | |
| Interaction with other | The action is due to an ongoing interaction with another |
| procedure | procedure. |
| Unknown PDU Session ID | The action failed because the PDU Session ID is unknown in the |
| | NG-RAN node |
| Unknown QoS Flow ID | The action failed because the QoS Flow ID is unknown in the |
| | NG-RAN node. |
| Multiple PDU Session ID | The action failed because multiple instance of the same PDU |
| instances | Session had been provided to/from the NG-RAN node. |
| Multiple QoS Flow ID | The action failed because multiple instances of the same QoS flow |
| instances | had been provided to the NG-RAN node. |
| Encryption and/or integrity | The NG-RAN node is unable to support any of the encryption |
| protection algorithms not | and/or integrity protection algorithms supported by the UE. |
| supported | |
| NG intra-system handover | The action is due to a NG intra-system handover that has been |
| triggered | triggered. |
| NG inter-system handover | The action is due to a NG inter-system handover that has been |
| triggered | triggered. |
| Xn handover triggered | The action is due to an Xn handover that has been triggered. |
| Not supported 5QI value | The QoS flow setup failed because the requested 5QI is not |
| | supported. |
| UE context transfer | The action is due to a UE resumes from the NG-RAN node |
| | different from the one which sent the UE into RRC_INACTIVE |
| | state. |
| IMS voice EPS fallback or | The setup of QoS flow is failed due to EPS fallback or RAT |
| RAT fallback triggered | fallback for IMS voice using handover or redirection. |
| UP integrity protection not | The PDU session cannot be accepted according to the required |
| possible | user plane integrity protection policy. |
| UP confidentiality protection | The PDU session cannot be accepted according to the required |
| not possible | user plane confidentiality protection policy. |
| Slice(s) not supported | Slice(s) not supported. |
| UE in RRC_INACTIVE state | The action is requested due to RAN paging failure. |
| not reachable | |
| Redirection | The release is requested due to inter-system redirection or |
| | intra-system redirection. |
| Resources not available for | The requested resources are not available for the slice(s). |
| the slice(s) | |
| UE maximum integrity | The request is not accepted in order to comply with the maximum |
| protected data rate reason | data rate for integrity protection supported by the UE. |
| Release due to CN-detected | The context release is requested by the AMF because the UE is |
| mobility | already served by another CN node (same or different system), or |
| | another NG interface of the same CN node. |
| N26 interface not available | The action failed due to a temporary failure of the N26 interface. |
| Release due to pre-emption | Release is initiated due to pre-emption. |
| Multiple Location Reporting | The action failed because multiple areas of interest are set with the |
| Reference ID Instances | same Location Reporting Reference ID. |
| RSN not available for the UP | The redundant user plane resources indicated by RSN are not |
| | available. |
| NPN access denied | Access was denied, or release is requested, for NPN reasons. |
| CAG only access denied | Access was denied because the cell is a non-CAG cell and UE is |
| | only allowed to access CAG cells. |
| Insufficient UE Capabilities | The procedure can't proceed due to insufficient UE capabilities. |
| RedCap UE not supported | The action failed because target NG-RAN node does not support |
| | RedCap UE. |
| Unknown MBS Session ID | The action failed because the MBS Session ID is unknown. |
| Indicated MBS Session Area | The action failed because the none of the cells in indicated MBS |
| Information not served by the | Session Area Information served by the NG-RAN node. |
| gNB | |
| Inconsistent slice info for the | The action failed because the slice info of the multicast session is |
| session | inconsistent. |
| Misaligned association for the | The action failed because the Associated Unicast QoS Flow ID has |
| multicast and unicast sessions | already been used, or the Associated Unicast QoS Flow ID is not |
| or flows | defined, or the Associated Unicast QoS Flow ID is not released, or |
| | multiple MBS QoS flows associated to the same unicast QoS flow, |
| | or same multicast session associated to multiple PDU Sessions. |
| IAB node emptied and/or | The RAN requests the IAB node release from the network after all |
| ready to be released and/or | the UEs and child/descendant nodes connected via the IAB node |
| deregistered and/or | are moved to other cells, served by other IAB nodes. |
| re-registered | |

Note that the Radio Network Layer cause “IAB node emptied and/or ready to be released and/or deregistered and/or re-registered” may be replaced by any other suitable cause with the similar/same meanings.

Embodiments herein may provide many advantages, of which a non-exhaustive list of examples follows. In some embodiments herein, it may enable the network to know that the IAB node is ready to be re-registered and/or de-registered and/or released from the network such as 5GS. In some embodiments herein, it may enable the network to trigger the release and/or the deregistration and/or the re-registration of IAB node without impacting the service of UEs and/or descendant IAB nodes and/or child IAB nodes (and their served UEs) connected via the IAB node. The embodiments herein are not limited to the features and advantages mentioned above. A person skilled in the art will recognize additional features and advantages upon reading the following detailed description.

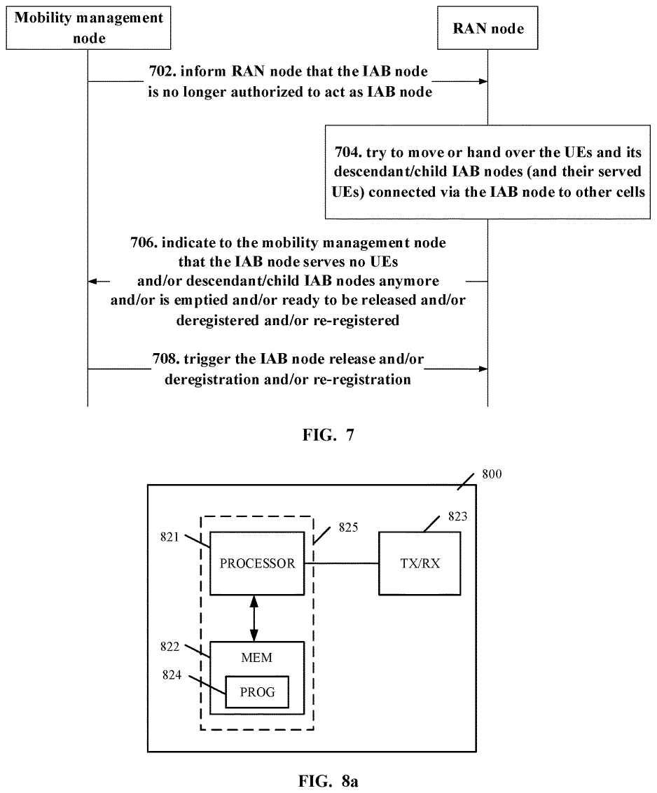

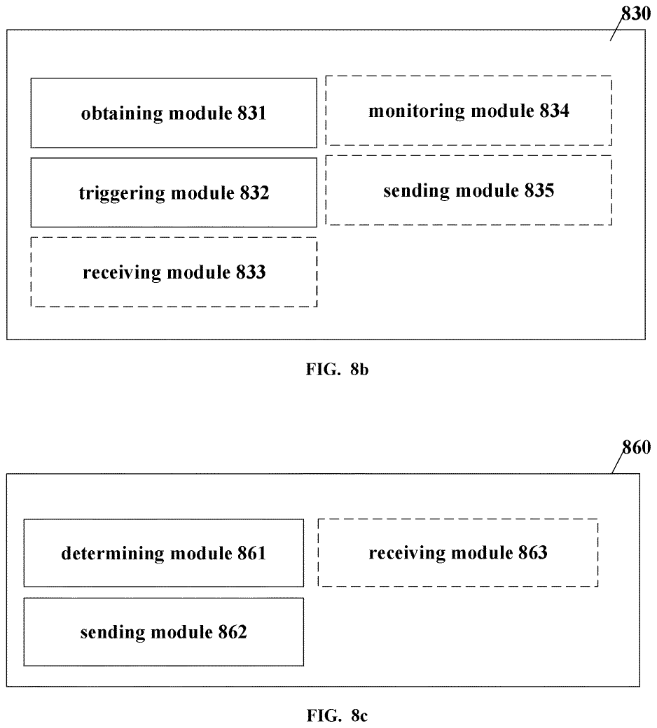

FIG. 8a is a block diagram showing an apparatus suitable for practicing some embodiments of the disclosure. For example, the mobility management node or the IAB donor described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the mobility management node, the memory 822 contains instructions executable by the processor 821, whereby the mobility management node operates according to any of the methods related to the mobility management node as described above.

In an embodiment where the apparatus is implemented as or at the IAB donor, the memory 822 contains instructions executable by the processor 821, whereby the IAB donor operates according to any of the methods related to the IAB donor as described above.

FIG. 8b is a block diagram showing a mobility management node according to an embodiment of the disclosure. As shown, the mobility management node 830 comprises an obtaining module 831 configured to obtain information that an integrated access and backhaul, IAB, node is emptied and/or ready to be released and/or deregistered and/or re-registered. The mobility management node 830 further comprises a triggering module 832 configured to trigger a procedure for a release and/or a deregistration and/or a re-registration of the IAB node.

In an embodiment, the mobility management node 830 further comprises a receiving module 833 configured to receive the information that the IAB node is emptied and/or ready to be released and/or deregistered and/or re-registered from an IAB donor serving the IAB node.

In an embodiment, the mobility management node 830 further comprises a monitoring module 834 configured to monitor at least one terminal device and/or at least one descendant IAB node and/or at least one child IAB node connected via the IAB node. The information that the IAB node is emptied and/or ready to be released and/or deregistered and/or re-registered may be obtained based on a monitoring result.

In an embodiment, the mobility management node 830 further comprises a sending module 835 configured to send to an IAB donor serving the IAB node a message informing the IAB donor that the IAB node is no longer authorized to act as IAB node.

FIG. 8c is a block diagram showing an IAB donor according to an embodiment of the disclosure. As shown, the IAB donor 860 comprises a determining module 861 configured to determine that an IAB node is emptied and/or ready to be released and/or deregistered and/or re-registered. The IAB donor 860 further comprises a sending module 862 configured to send information that the IAB node is emptied and/or ready to be released and/or deregistered and/or re-registered to a mobility management node. The information that an IAB node is emptied and/or ready to be released and/or deregistered and/or re-registered may be used by the mobility management node to trigger a procedure for a release and/or a deregistration and/or a re-registration of the IAB node.

In an embodiment, the IAB donor 860 further comprises a receiving module 863 configured to receive a message informing the IAB donor that the IAB node is no longer authorized to act as IAB node from the mobility management node.

Further, the exemplary overall commutation system including the terminal device (such as UE or IAB node) and the network node (such as the mobility management node or the IAB donor) will be introduced as below.

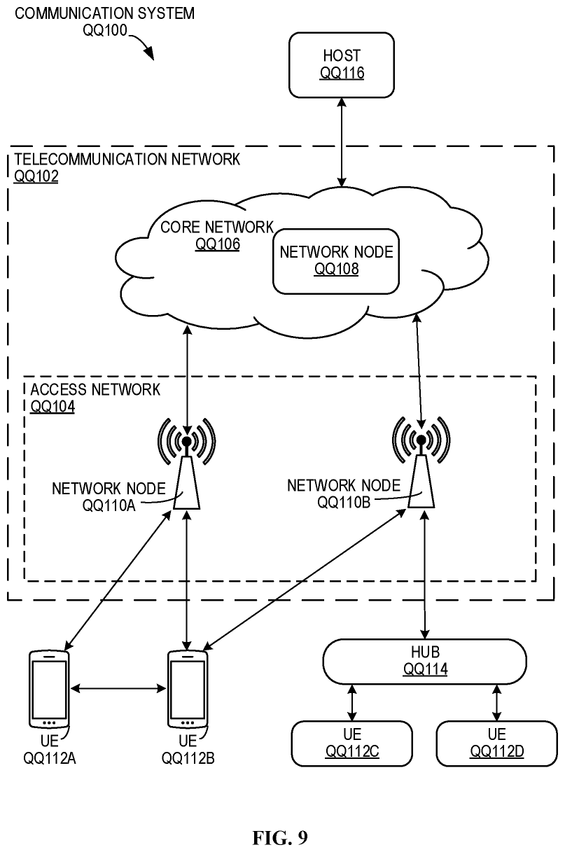

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

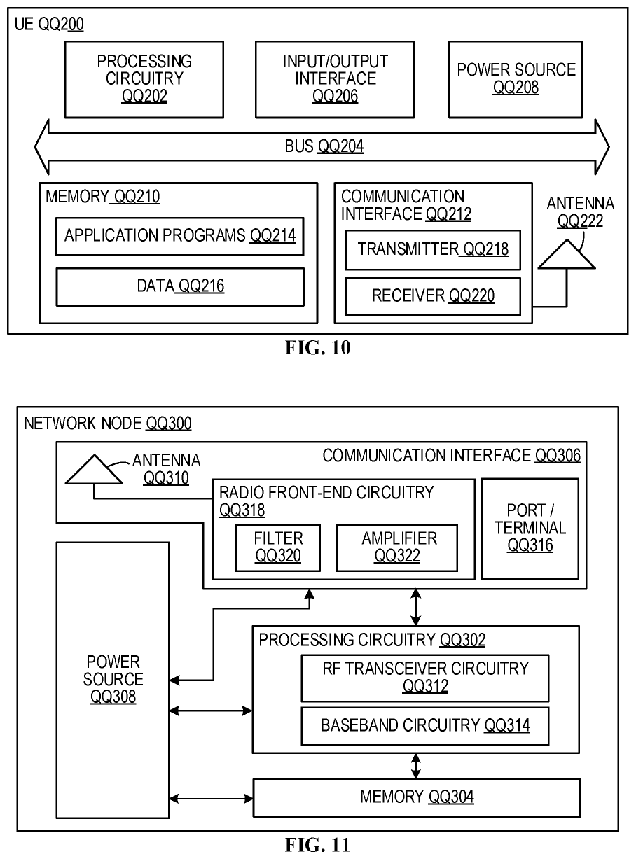

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O & M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

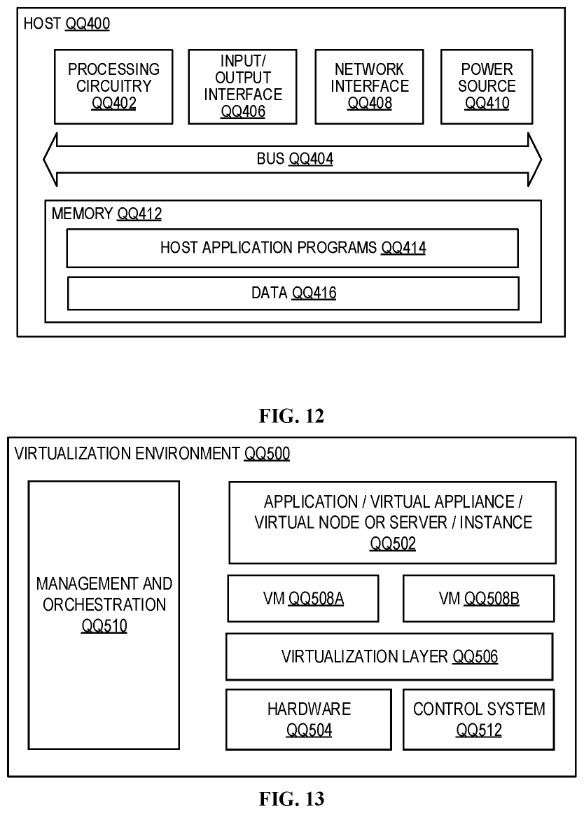

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

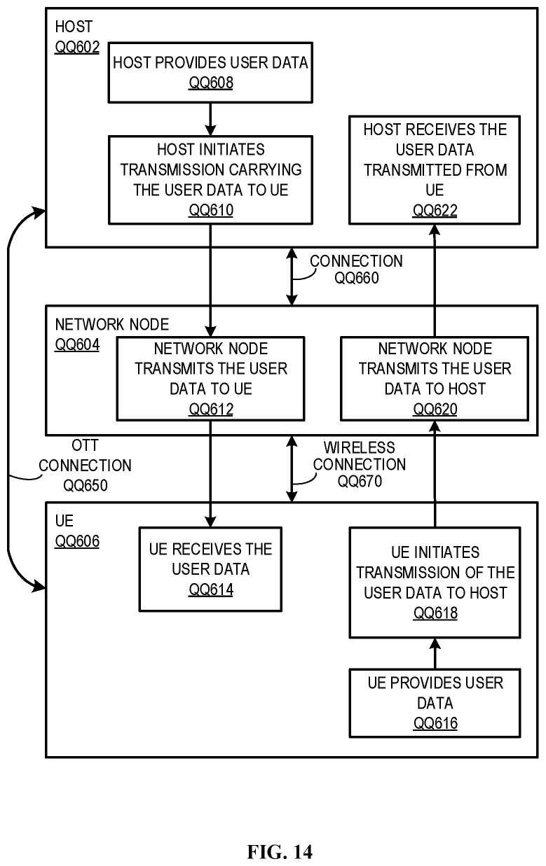

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508A and QQ508B (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, it may enable the network to know that the IAB node is ready to be re-registered and/or de-registered and/or released from the network such as 5GS. In some embodiments herein, it may enable the network to trigger the release and/or the deregistration and/or the re-registration of IAB node without impacting the service of UEs and/or descendant IAB nodes and/or child IAB nodes (and their served UEs) connected via the IAB node.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform any of the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs any of the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the mobility management node or the IAB donor may not need a fixed processor or memory, any computing resource and storage resource may be arranged from the mobility management node or the IAB donor in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

For the avoidance of doubt, the following numbered statements set out embodiments of the disclosure:
1. A method (200) performed by a mobility management node, comprising:
   obtaining (202) information that an integrated access and backhaul, IAB, node is emptied and/or ready to be released and/or deregistered and/or re-registered; and
   triggering (204) a procedure for a release and/or a deregistration and/or a re-registration of the IAB node.
2. The method according to statement 1, wherein the information that the IAB node is emptied and/or ready to be released and/or deregistered and/or re-registered indicates at least one of:
   the IAB node does not serve any terminal device and/or any descendant IAB node and/or any child IAB node, or
   all terminal devices and/or all descendant IAB nodes and/or all child IAB nodes connected via the IAB node are moved or handed over to at least one other cell and/or served by at least one other IAB node or other radio access network, RAN, node or released, or
   a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.
3. The method according to statement 1 or 2, further comprising:
   receiving (302) the information that the IAB node is emptied from an IAB donor serving the IAB node.
4. The method according to statement 3, wherein the information that the IAB node is emptied and/or ready to be released and/or deregistered and/or re-registered is received from the IAB donor serving the IAB node in a next generation application protocol message or an S1 application protocol message.
5. The method according to any of statements 1-4, wherein the information that the IAB node is emptied and/or ready to be released and/or deregistered and/or re-registered is comprised in a user equipment context release request or in a cause parameter, wherein the cause parameter is added with a cause value indicating the IAB node is emptied and/or ready to be released and/or deregistered and/or re-registered.
6. The method according to any of statements 1-5, wherein the information that the IAB node is emptied and/or ready to be released and/or deregistered and/or re-registered comprises at least one of:
   single information indicating that the IAB node no longer serves a terminal device and a descendant IAB node and a child IAB node, or
   first information indicating that the IAB node no longer serves a terminal device and/or second information indicating that the IAB node no longer serves a descendant IAB node and/or a child IAB node.
7. The method according to any of statements 1-6, further comprises:
   monitoring (402) at least one terminal device and/or at least one descendant IAB node and/or at least one child IAB node connected via the IAB node,
   wherein the information that the IAB node is emptied and/or ready to be released and/or deregistered and/or re-registered is obtained based on a monitoring result.
8. The method according to statement 7, wherein the monitoring is performed when the IAB node, one or more terminal devices served by the IAB node, one or more descendant IAB nodes of the IAB node and one or more terminal devices served by the descendant IAB nodes are served by a same mobility management node.
9. The method according to statement 8, wherein when all terminal devices served by the IAB node and all child IAB nodes of the IAB node have been handed over or moved to at least one other cell or served by at least one other IAB node or other RAN node or released, the procedure for the release and/or the deregistration and/or the re-registration of the IAB node is triggered.
10. The method according to any of statements 1-9, further comprising:
   sending (502) to an IAB donor serving the IAB node a message informing the IAB donor that the IAB node is no longer authorized to act as IAB node.
11. The method according to any of statements 1-10, wherein the mobility management node comprises at least one of:
   an access and mobility management function, AMF, or
   a mobile management entity, MME.
12. A method (600) performed by an IAB donor, comprising:
   determining (604) that an IAB node is emptied and/or ready to be released and/or deregistered and/or re-registered; and
   sending (606) information that the IAB node is emptied and/or ready to be released and/or deregistered and/or re-registered to a mobility management node,
   wherein the information that an IAB node is emptied and/or ready to be released and/or deregistered and/or re-registered is used by the mobility management node to trigger a procedure for a release and/or a deregistration and/or a re-registration of the IAB node.
13. The method according to statement 12, wherein the information that the IAB node is emptied and/or ready to be released and/or deregistered and/or re-registered indicates at least one of:
   the IAB node does not serve any terminal device and/or any descendant IAB node and/or any child IAB node, or
   all terminal devices and/or all descendant IAB nodes and/or all child IAB nodes connected via the IAB node are moved or handed over to at least one other cell and/or served by at least one other IAB node or other radio access network, RAN, node or released, or
   a RAN node requests the release and/or the deregistration and/or the re-registration of the IAB node after all terminal devices and/or all child IAB nodes and/or all descendant IAB nodes connected via the IAB node are handed over or moved to at least one other cell or served by at least one other IAB node or other RAN node or released.
14. The method according to statement 12 or 13, wherein the information that the IAB node comprises at least one of:
   single information indicating that the IAB node no longer serves a terminal device and a descendant IAB node and a child IAB node, or
   first information indicating that the IAB node no longer serves a terminal device and/or second information indicating that the IAB node no longer serves a descendant IAB node and/or a child IAB node.
15. The method according to any of statements 12-14, wherein the information that the IAB node is emptied and/or ready to be released and/or deregistered and/or re-registered is sent to the mobility management node in next generation application protocol message or an S1 application protocol message.
16. The method according to any of statements 12-15, wherein the information that the IAB node is emptied and/or ready to be released and/or deregistered and/or re-registered is comprised in a user equipment context release request or in a cause parameter, wherein the cause parameter is added with a cause value indicating the IAB node is emptied and/or ready to be released and/or deregistered and/or re-registered.
17. The method according to any of statements 12-16, further comprising:
   receiving (602) a message informing the IAB donor that the IAB node is no longer authorized to act as IAB node from the mobility management node.
18. The method according to any of statements 12-17, wherein the mobility management node comprises at least one of:
   an access and mobility management function, AMF, or
   a mobile management entity, MME.
19. A mobility management node (800), comprising:
   a processor (821); and
   a memory (822) coupled to the processor (821), said memory (822) containing instructions executable by said processor (821), whereby said mobility management node (800) is operative to:
   obtain information that an integrated access and backhaul, IAB, node is emptied and/or ready to be released and/or deregistered and/or re-registered; and
   trigger a procedure for a release and/or a deregistration and/or a re-registration of the IAB node.
20. The mobility management node according to statement 19, wherein the mobility management node is further operative to perform the method of any one of statements 2 to 11.
21. An IAB donor (800), comprising:
   a processor (821); and
   a memory (822) coupled to the processor (821), said memory (822) containing instructions executable by said processor (821), whereby said IAB donor (800) is operative to:
determine that an IAB node is emptied and/or ready to be released and/or deregistered and/or re-registered; and
   send information that the IAB node is emptied and/or ready to be released and/or deregistered and/or re-registered to a mobility management node,
   wherein the information that an IAB node is emptied and/or ready to be released and/or deregistered and/or re-registered is used by the mobility management node to trigger a procedure for a release and/or a deregistration and/or a re-registration of the IAB node.
22. The IAB donor according to statement 21, wherein the IAB donor is further operative to perform the method of any one of statements 13 to 18.
23. A computer-readable storage medium storing instructions which when executed by at least one processor, cause the at least one processor to perform the method according to any one of statements 1 to 18.
24. A computer program product comprising instructions which when executed by at least one processor, cause the at least one processor to perform the method according to any one of statements 1 to 18.

1. A method performed by a mobility management node, comprising:
obtaining information that an integrated access and backhaul, IAB, (IAB) node is ready to be deregistered; and
triggering a procedure for a deregistration of the IAB node.

2. The method according to claim 1, wherein the information that the IAB node is ready to be deregistered indicates at least one of:
the IAB node does not serve any terminal device and/or any descendant IAB node and/or any child IAB node, or
all terminal devices and/or all descendant IAB nodes and/or all child IAB nodes connected via the IAB node are moved or handed over to at least one other cell and/or served by at least one other IAB node or other radio access network (RAN) node or released, or
a RAN node requests the deregistration of the IAB node after all terminal devices and/or all child IAB nodes and/or all descendant IAB nodes connected via the IAB node are handed over or moved to at least one other cell or served by at least one other IAB node or other RAN node or released.

3. The method according to claim 1, further comprising:
receiving the information that the IAB node is ready to be deregistered from an IAB donor serving the IAB node.

4. The method according to claim 3, wherein the information that the IAB node is ready to be deregistered is received from the IAB donor serving the IAB node in a next generation application protocol message or an S1 application protocol message.

5. The method according to claim 1, wherein the information that the IAB node is ready to be deregistered is comprised in a user equipment context release request or in a cause parameter, wherein the cause parameter is added with a cause value indicating the IAB node is ready to be deregistered.

6. The method according to claim 1, wherein the information that the IAB node is ready to be deregistered comprises at least one of:
single indication indicating that the IAB node no longer serves a terminal device and a descendant IAB node and a child IAB node, or
first information indicating that the IAB node no longer serves a terminal device and/or second information indicating that the IAB node no longer serves a descendant IAB node and/or a child IAB node.

7. The method according to claim 1, further comprises:
monitoring at least one terminal device and/or at least one descendant IAB node and/or at least one child IAB node connected via the IAB node,
wherein the information that the IAB node is ready to be deregistered is obtained based on a monitoring result.

8. The method according to claim 7, wherein the monitoring is performed when the IAB node, one or more terminal devices served by the IAB node, one or more descendant IAB nodes of the IAB node and one or more terminal devices served by the descendant IAB nodes are served by a same mobility management node.

9. The method according to claim 8, wherein when all terminal devices served by the IAB node and all child IAB nodes of the IAB node have been handed over or moved to at least one other cell or served by at least one other IAB node or other RAN node or released, the procedure for the deregistration of the IAB node is triggered.

10. The method according to claim 1, further comprising:
sending to an IAB donor serving the IAB node a message informing the IAB donor that the IAB node is no longer authorized to act as IAB node.

11. The method according to a claim 1, wherein the mobility management node comprises at least one of:
an access and mobility management function (AMF) or a mobile management entity (MME).

12. A method performed by an IAB donor, comprising:
determining that an IAB node is ready to be deregistered; and
sending information that the IAB node is ready to be deregistered to a mobility management node,
wherein the information that an IAB node is ready to be deregistered is used by the mobility management node to trigger a procedure for a deregistration of the IAB node.

13. The method according to claim 12, wherein the information that the IAB node is ready to be deregistered indicates at least one of:
the IAB node does not serve any terminal device and/or any descendant IAB node and/or any child IAB node, or
all terminal devices and/or all descendant IAB nodes and/or all child IAB nodes connected via the IAB node are moved or handed over to at least one other cell and/or served by at least one other IAB node or other radio access network, (RAN) node or released, or
a RAN node requests the deregistration of the IAB node after all terminal devices and/or all child IAB nodes and/or all descendant IAB nodes connected via the IAB node are handed over or moved to at least one other cell or served by at least one other IAB node or other RAN node or released.

14. The method according to claim 12, wherein the information that the IAB node is ready to be deregistered comprises at least one of:
single indication indicating that the IAB node no longer serves a terminal device and a descendant IAB node and a child IAB node, or
first information indicating that the IAB node no longer serves a terminal device and/or second information indicating that the IAB node no longer serves a descendant IAB node and/or a child IAB node.

15. The method according to claim 12, wherein the information that the IAB node is ready to be deregistered is sent to the mobility management node in a next generation application protocol message or an S1 application protocol message.

16. The method according to claim 12, wherein the information that the IAB node is ready to be deregistered is comprised in a user equipment context release request or in a cause parameter, wherein the cause parameter is added with a cause value indicating the IAB node is ready to be deregistered.

17. The method according to claim 12, further comprising:
receiving, from the mobility management node, a message informing the IAB donor that the IAB node is no longer authorized to act as IAB node.

18. The method according to claim 12, wherein the mobility management node comprises at least one of:
an access and mobility management function (AMF), or
a mobile management entity (MME).

19. A mobility management node, comprising:
a processor; and
a memory coupled to the processor said memory containing instructions executable by said processor, whereby said mobility management node is operative to:
obtain information that an integrated access and backhaul (IAB) node is ready to be deregistered; and
trigger a procedure for a deregistration of the IAB node.

20. The mobility management node according to claim 19, wherein the mobility management node is further operative to send, to an IAB donor serving the IAB node, a message informing the IAB donor that the IAB node is no longer authorized to act as IAB node.

21. An IAB donor, comprising:
a processor; and
a memory coupled to the processor, said memory containing instructions executable by said processor, whereby said IAB donor is operative to:
determine that an IAB node is ready to be deregistered; and
send information that the IAB node is ready to be deregistered to a mobility management node,
wherein the information that an IAB node is ready to be deregistered is used by the mobility management node to trigger a procedure for a deregistration of the IAB node.

22. The IAB donor according to claim 21, wherein the IAB donor is further operative to receive, from the mobility management node, a message informing the IAB donor that the IAB node is no longer authorized to act as LAB node.

23. (canceled)

24. (canceled)
